(19) United States
(12) Patent Application Publication
(10) Pub. No.: US 2012/0187129 A1
(43) Pub. Date: Jul. 26, 2012

(54) Apparatus for tethering a cap for a sprayer tank to the tank

(76) Inventors: John D. DeLorme, Spencerport, NY (US); Ronald M. Odessa, Batavia, NY (US)

(21) Appl. No.: 12/930,928

(22) Filed: Jan. 20, 2011

(51) Int. Cl. B65D 55/16; B23P 19/04; B65D 53/00

(52) U.S. Cl. 220/375; 220/378; 29/428

(57) ABSTRACT

Apparatus providing a tethered cap for a fill opening of a sprayer tank which is tethered inside, rather than outside the tank, via a tether line movably attached to a basket suspended in the tank, and having a gasket at an upper end of the basket which is engaged by the cap to seal the fill opening in the tank when the cap is closed. The tether line extends through the gasket so that the basket, the gasket, and the cap are tethered to each other. Since the tether line is inside the tank, catching or snagging of the line and the cap on obstacles, such as trees, or branches, is precluded. The cap remains connected to the sprayer tank when it is removed from the tank in order to fill the tank and misplacement of the cap is also precluded even though the cap is not held by the sprayer operator while the tank is being filled.

The present invention relates to sprayer apparatus, and particularly to a tethered cap for opening and closing an opening into a sprayer tank which enables the tank to be filled thereby preventing misplacement or loss of a cap if it is not held by the operator during filling operations. The cap is tethered inside the tank, rather than outside thereof, to prevent the cap and its tether from being caught on obstructions, such as branches or trees in the vicinity where the sprayer is used. Also, the loss or misplacement of the cap is prevented, since it remains connected to the sprayer even if the operator does not hold the cap during filling of the tank. Since the cap need not be held by the operator, care of the cap during filling operations and possible loss or misplacement thereof is precluded, thus simplifying filling operations.

The present invention is especially adapted to facilitate spraying with sprayers which have openings in the sprayer tank for filling which are separate from openings in which a pump mechanism is used for locating a pump mechanism of the sprayer inside the sprayer tank. When the same opening is used for the pump mechanism and for filling the tank, the shaft from a handle for operating the pump mechanism extends through the cap and effectively captures the cap. Such sprayers with the pump handle extending through the cap are shown for example in U.S. Pat. No. D564,068, issued to James W. Campbell on Mar. 11, 2008. Sprayers with an opening for filling the tank separate from the opening in which the pump mechanism is mounted are usually carried on the back of the operator and are known as backpack sprayers. Such sprayers are of the type where the pump mechanism opening is at the bottom of the tank and are shown for example in U.S. Pat. No. 4,690,331, issued Sep. 1, 1987, and U.S. Pat. No. 4,798,333, issued Jan. 17, 1989, both to Luchsinger, and U.S. Pat. No. 5,335,853, issued Aug. 9, 1994, to Wirz. Tanks for such backpack sprayers are also shown in U.S. Design Pat. No. D591,387, issued Apr. 28, 2009 to Campbell, and also U.S. Design Pat. No. D570,447, issued Jun. 3, 2008 to Hillhouse. See also U.S. Pat. No. 2,594,223, issued Apr. 22, 1952 to Santarelli, and U.S. Pat. No. 4,881,687, issued Nov. 21, 1989 to Ballu. Backpack sprayers having an opening for the pump mechanism and a fill opening on the top of the sprayer tank are known as European style backpack sprayers, and are shown, for example, in U.S. Design Pat. No. D582,000, issued Dec. 2, 2008 to Campbell. These fill openings are closed by caps which are removed when the tank is to be filled with fluid to be sprayed. The filling operation is complicated and made more difficult when the operator must hold the cap after it is removed from the fill opening since the cap can drop on the ground, roll away from the sprayer, or otherwise become misplaced or lost.

It is the principal feature of the present invention to provide a tethered cap which holds the cap assembled to the sprayer even when the cap is removed for filling the sprayer, thus facilitating and simplifying spraying operations.

It is a further feature of the present invention to provide a cap, a filter basket, which is suspended in the tank via the fill opening to prevent dirt, leaves and other undesirable contaminants from entering the sprayer tank during filling operations, as well as a gasket disposable around the fill opening so as to seal the cap and the tank when the cap is closed, in which the basket, gasket and cap are in tethered relationship thereby insuring that the cap remains on the fill opening and the gasket remains in position over the fill opening to provide sealing and prevent leaks of spraying fluid out of the tank during spraying operations or when the tank is not maintained substantially upright.

Briefly described, the present invention embodies a tethered cap for closing and opening a throat providing an opening into a sprayer tank cap utilizing a flexible tether line connected at one end thereof to the cap on the inside of the cap which faces the tank when the cap is closed. The tether extends to a member inside the tank and is movably captured at an end thereof opposite to the end connected to the cap, to that member. This member is preferably provided at or by the bottom of a filter basket which is suspended in the tank from the throat. The filter basket has an outside surface with openings providing filtering against the passage of debris and other unwanted material into the tank with the fluid or otherwise while the tank is being filled or the cap is open. The bottom of the filter basket may provide the member having an opening sized with respect to the tether line so that the line can move with the cap when the cap is open. The opposite end of the tether line is enlarged to be larger than the opening at the bottom of the filter basket and the tether line is captured in the opening. The tether line is prevented from leaving the filter basket and tethers the cap inside the tank. Where a gasket is disposed around the fill opening so as to be compressed to seal the tank when the cap is closed, the tether line extends through the gasket so that the gasket, the cap and the basket are tethered to each other. Since tethering is accomplished internally of the tank, snagging or catching on obstacles, such as branches, trees and shrubbery which may be encountered during spraying operations, is avoided. Also, since the cap is always tethered to the tank, the misplacement and loss thereof as when the cap is allowed to fall on the ground, is avoided.

The present invention further embodies a method for tethering a cap to a sprayer tank comprising the step of coupling one end of a tether inside of a cap which opens and closes an opening to the tank, and coupling the other end of the tether, via the opening to the tank, to a member in the tank, in which the tether is of sufficient length when the cap is removed to enable an operator access to the opening while tethering the cap to tank by the tether. The tether may be slidable through the opening of the member in which the other end of the tether is larger than the opening such that the member and tether are always retained coupled to each other. The member may be the bottom of a filter basket having a ring captured by a gasket along the opening to the tank.

The foregoing and other objects, features and advantages of the invention will become more apparent from a reading of the following description in connection with the accompanying drawings in which:

FIG. 1 is a top view of a tank of a European style backpack sprayer, of the type shown in the above-referenced U.S. Pat. No. D582,000; the tank having a tethered cap mechanism in accordance with the invention;

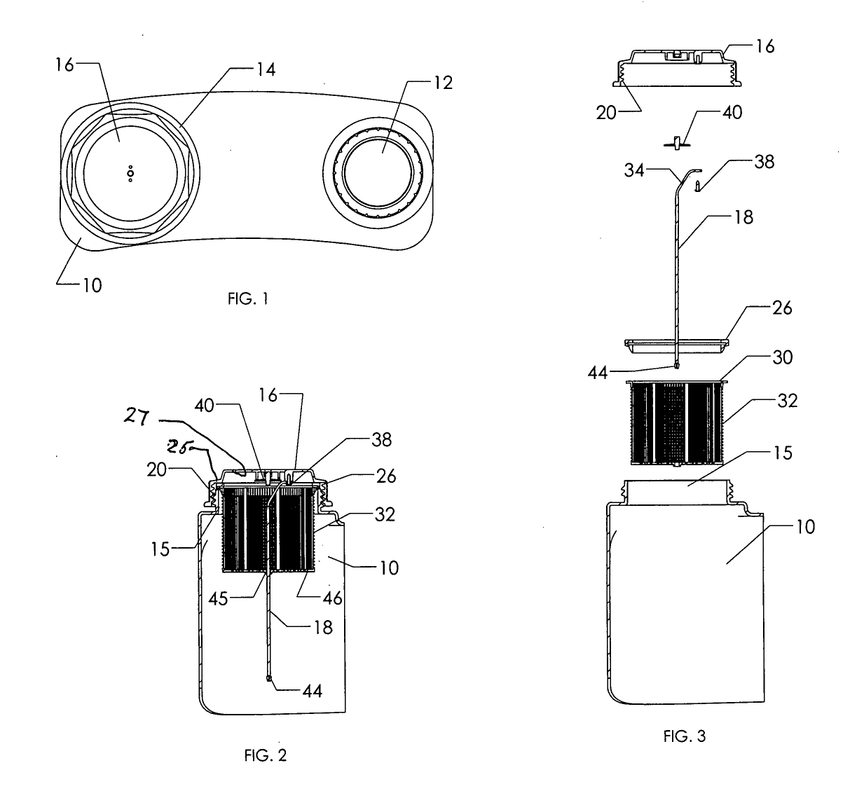

FIG. 2 is a sectional view taken along the line 2-2 in FIG. 1, showing the tank, and the tethered cap on a throat providing a fill opening into the tank, the cap being shown closing the fill opening;

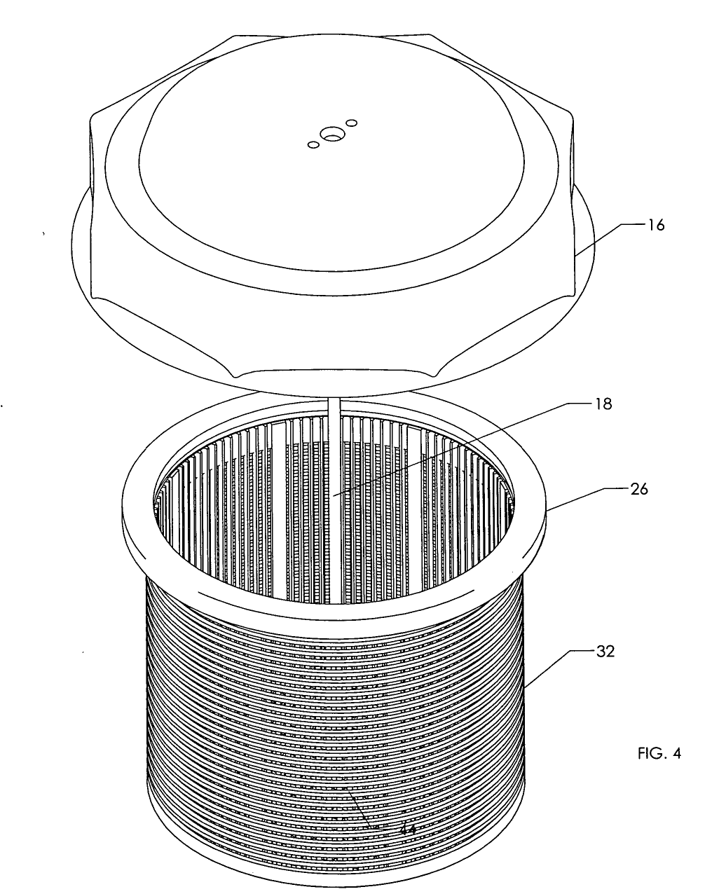

FIG. 3 is an exploded view similar to FIG. 2 of the thank, tethered cap and the apparatus for tethering the cap;

FIG. 4 is a perspective view of the tethered cap, the tether line, the filter basket and the gasket on the top of the filter basket which is engaged so as to seal the tank at the fill opening when the cap is closed;

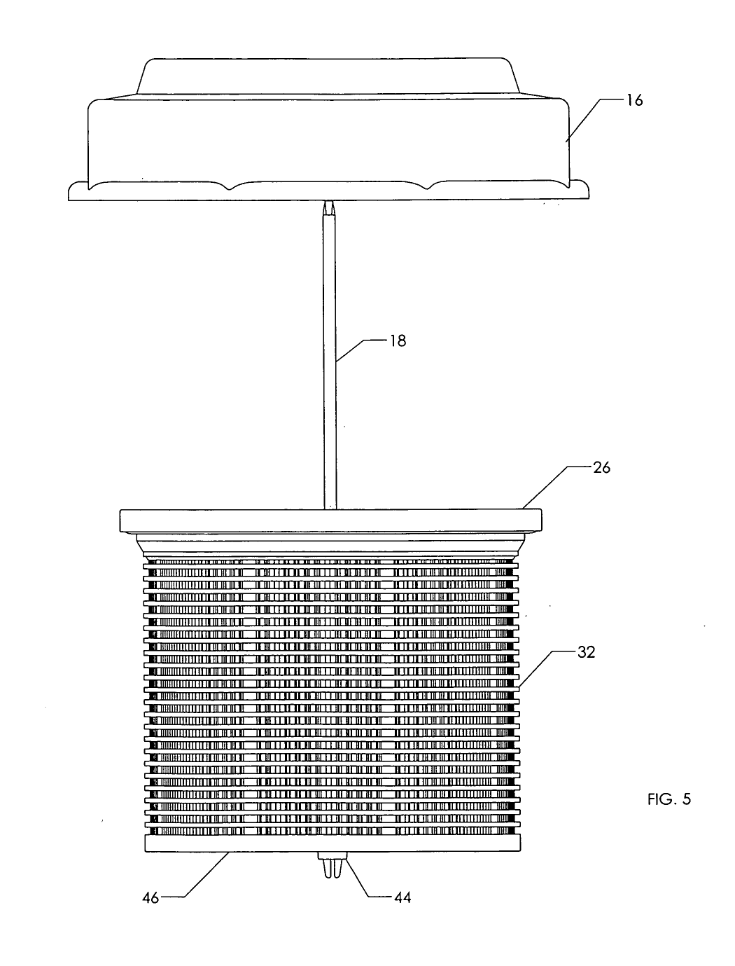

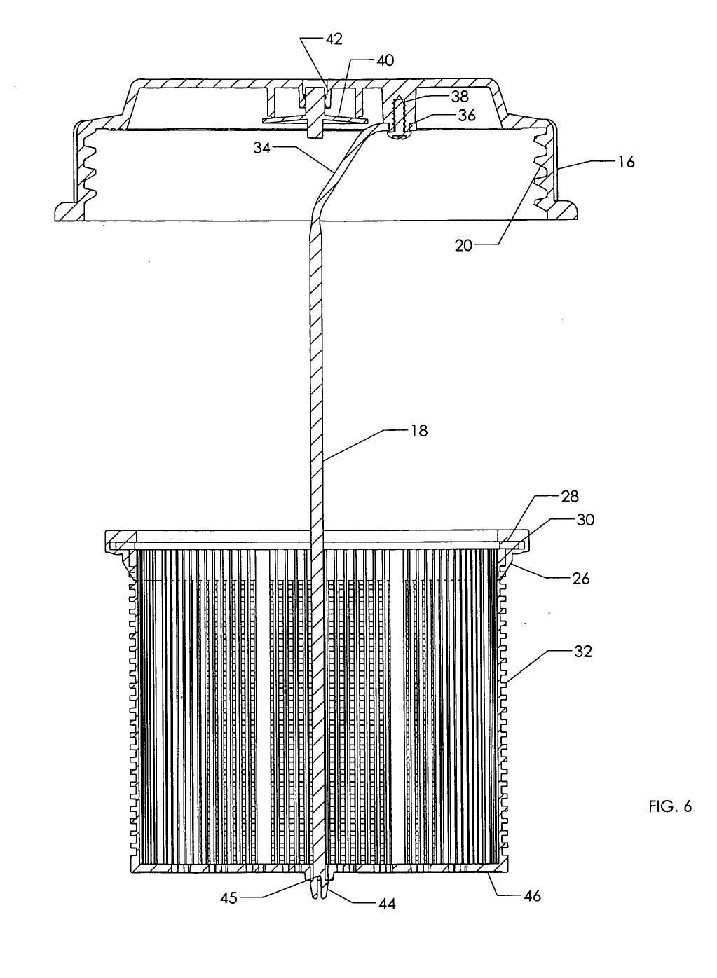

FIG. 5 is an elevational view of the tethered cap and tethering apparatus shown in FIG. 4;

FIG. 6 is a sectional view of the cap, basket, gasket and tether line, the section also being along a diameter through the center of the cap, similar to the section 2-2 shown in FIG. 1;

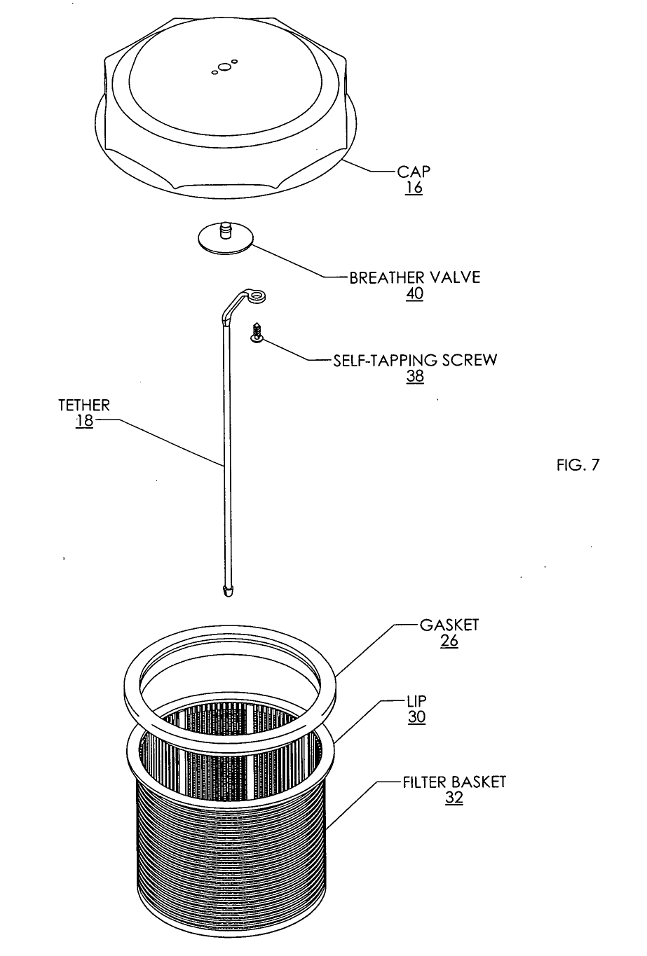

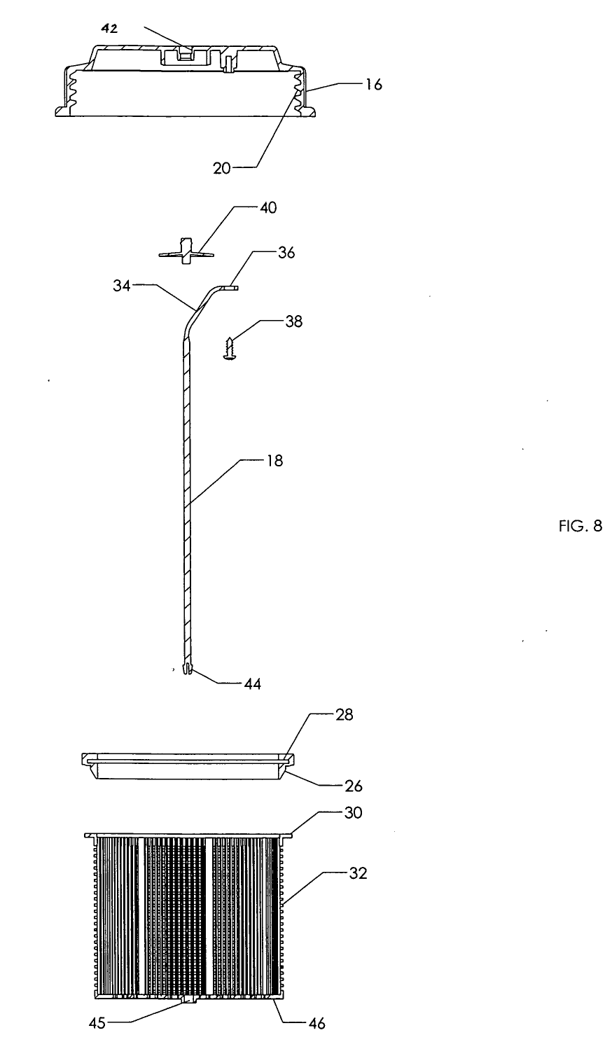

FIG. 7 is an exploded view of the tethering apparatus shown in FIG. 6; and

FIG. 8 is an exploded view similar to FIG. 7 showing the cap, gasket, filter basket and tether line in section along a diametric sectional line similar to line 2-2 in FIG. 1.

Referring to FIGS. 1, 2 and 3, there is shown the tank 10 of a European style backpack sprayer having an opening 12 in which the pump mechanism (not shown) of the sprayer is disposed and a fill opening 14 in a throat or neck 15. The fill opening is closed by a cap 16. The cap and the tethering apparatus for the cap 16 providing a tethered cap inside the sprayer tank 10 is also shown in FIGS. 4-8.

The tethering apparatus includes a tether line 18 which is a rope-like member which is flexible. The rope may be a plastic member, a flexible metal wire, or a fiber rope, the material being selected to be compatible with the fluid which is used to fill the tank for spraying purposes. As best shown in FIG. 6, the tethered cap 16 is generally cylindrical and is internally threaded at 20 so as to be threadedly disposed on a complimentary thread on the throat of the fill opening as shown in FIGS. 1-3. The cap 16 has a flange or lip 25 at the bottom 27 thereof which engages a gasket 26 having a groove 28 which is captured in a lip 30 at the upper end of the filter basket 32, the basket 32 itself having criss-cross wires and ribs with openings for passing fluid, but capturing debris and other extraneous materials.

A connector 34 at the top of the tether line 18 has an opening 36 for a self-tapping screw 38 which connects the upper end of the tether line 18 to the inside (which faces the tank) of cap 16 when cap 16 is closed. A breather valve 40 is also inserted in an opening 42 (FIG. 7) at the top of the cap 16 and held inside the cap above the threads 20. The tether 18 is sufficiently long so that it holds cap 16 in position adjacent to the sprayer tank 10 when the cap is removed. The cap 16 then cannot fall on the ground because the lower end 44 of the tether line 18 is enlarged so that it has a cross-sectional size larger than an opening or hole 45 in the bottom 46 of the basket 32. Otherwise, the size of the tether 18 allows the tether to move downwardly into the tank 10 (sliding through opening 45) as shown in FIGS. 1 and 2 so that the tether does not interfere with the closing of cap 16. The tether 18 extends through the gasket 26 and effectively tethers not only cap 16, but also the gasket 26 and the basket 32 to each other.

In operation, tank 10 may be opened for filling by the operator rotating cap 20 in a first direction to unscrew the cap 16 by its threads 20 from the externally threaded throat 15 of fill opening 14 until cap 16 disengages from fill opening 14. Then, lifting cap 16 upwards away from tank 10 tether 18 moves or slides upwards through opening 45 of filter basket 32 until enlarged end 44 (as shown in FIG. 6). Tether 18 may be sufficiently flexible, such that cap 16 can be released by the operator and the cap leans to one side for ease of filling without tether 18 sliding back through opening 45, but not so flexible that the tether would buckle rather than move or slides up or down through basket opening 45. Tether 18 is of sufficient length to enable removal of the cap 16 and provide access to fill opening 14 for filling. For example, tether 18 may be proportional in length to the height of the cap 16 and the basket 32 as shown in FIG. 6. While the tether 18 is flexible, its flexibility is not enough, considering the length of the tether 18, that the tether could get caught under the cap 16 or gasket 26 to allow leakage from the tank 10. The tether 18 also disappears through the opening 45 at the bottom of the basket 32 which also prevents the tether 18 from getting caught under the cap 16 or gasket 26 when the cap closes the tank.

Optionally, the cap 16 when lifted by an operator away from fill opening 14 may continue to be lifted upwards after the tether's enlarged end 44 abuts opening 45 of the filter basket 32 thereby pulling the filter basket 32 and also gasket 26 away from tank 10 and removing the filter basket 32 and gasket 26 from the tank 10. When so removed from tank 10, the cap 16, gasket 26, and filter basket 32 remain tethered together by upper and lower ends of tether 18 being captured by cap 16 and basket 32, respectively, reducing risk of loss of these components if they were not so tethered. Such removal of the filter basket 32 from being suspended in the throat of opening 14 may be for cleaning or other maintenance of the filter basket.

With access to fill opening 14 provided, the tank 10 is then filled with the desired liquid to be sprayed. When filling is complete, the operator positions cap 16 back over fill opening 14 (and positions gasket 26 and filter basket 32 back in place with respect to fill opening 14, if they were removed). During positioning of cap 16 back over opening 14 the tether 18 slides downwardly through opening 45 of filter basket 32. Cap 16 is then rotated by the operator in a second opposite direction to screw the cap by its threads 20 over throat 15 of fill opening 14 (as shown in FIG. 2) to reengaged the cap with opening 14 thereby closing tank 10.

The sprayer may then be operated as a typical sprayer to spray the liquid in tank 10 after operation of the sprayer's pump mechanism. By tether 18 being internal of tank 10, rather than external thereof, tether 18 is prevented from snagging or otherwise catching on obstacles, such as branches, trees and shrubbery, which may be encountered during spraying operations.

The bottom 46 of the filter basket 32 provides a member having an opening (or hole) sized with respect to the tether 18 so that the tether can move upward or downward there through, where upward movement is limited by end 44. Such member is not limited to a filter basket and may or may not have a filter, as another member having an opening similarly sized to opening 45 may be used so long as such member cannot readily be removed by the operator from tank 10 via fill opening 14 when the cap 16 is removed and displaced away from opening 14, as described above for filing, and such member does not interfere with filling.

From the foregoing description, it will be apparent that there has been provided improved sprayer apparatus and particularly, a tethered cap and a mechanism for tethering the cap inside a sprayer tank having a fill opening which is opened and closed by the cap. Variations and modifications within the scope of the invention will undoubtedly suggest themselves to those skilled in the art. Accordingly, the foregoing description should be taken as illustrative and not in a limiting sense.

What is claimed is:

1. Apparatus for tethering a cap for opening and closing a fill opening of a sprayer tank internally of the tank, and including a gasket for the cap around the fill opening and separable from the tank and also including a filter basket which is disposable in the tank via the fill opening wherein the cap gasket and the basket are in tethered relationship, said apparatus comprising a flexible tether line movably connected to the basket, said tether line being disposed inside the gasket, said tether line being connected at one end thereof to said cap on a side inside of said cap which side faces said fill opening when closed by said cap, and said tether line being sufficiently long to reach said cap when said cap is removed from said fill opening to open said fill opening for filling the tank.

2. The apparatus according to claim 1 wherein said basket has an open top end in said fill opening when said basket is disposed in said tank, and said basket has a member at a bottom end thereof with an opening in which said tether line is movably captured.

3. The apparatus according to claim 2 wherein said tether line has an end opposite to said one end thereof which extends through said opening in said member, said opposite end of said tether line having a cross-section larger than the cross-section of the opening in said member at the bottom of said basket for limiting movement of said tether line with said cap in a direction out of said sprayer tank.

4. The apparatus according to claim 3 wherein said member is a closed bottom end of said basket.

5. The apparatus according to claim 1 wherein said tether line is a flexible rope-like member.

6. The apparatus according to claim 6 wherein said gasket is a ring disposable around the end of a throat of said tank which provides said fill opening.

7. A tethered cap for closing and opening a throat providing an opening into a sprayer tank which comprises a flexible tether line connected at one end thereof to said cap which is on an inside thereof when said cap closes said throat, said tether line extending inside said throat into said tank and being captured at an end thereof opposite to said one end to said tank inside said tank.

8. The tethered cap according to claim 7 further comprising a member inside said tank providing an attachment via which said tether line is movably attached to said member.

9. The tethered cap according to claim 8 wherein said attachment is provided by an opening in said member via which said tethered line extends in a direction toward the inside of said tank, said opening being larger than said tether line and cross-section except at said opposite end thereof for limiting travel of said cap and said tether when said cap is removed from said throat to open said tank.

10. The tethered cap according to claim 9 wherein said tethered line is of sufficient length between the ends thereof to enable removal of said cap from said throat for filling of said tank and for removal of a filter basket suspended in said throat into said tank, said removal of said basket enabling cleaning or other maintenance thereof.

11. The tethered cap according to claim 10 wherein said member with said opening for said tethered line is part of said basket.

12. The tethered cap according to claim 11 wherein said member is a bottom of said basket.

13. The tethered cap according to claim 7 wherein said tethered line is a rope of flexible material, metal, plastic or fiber which is compatible with fluid with which said tank is filled.

14. The tethered cap according to claim 7 wherein a gasket is provided along the periphery of an end of said throat which is engaged when said throat is closed by said cap, said tethered line extending through and also tethering said gasket with said cap.

15. A method for tethering a cap to a sprayer tank comprising the steps of:
coupling one end of a tether inside of a cap which opens and closes an opening to the tank; and
coupling the other end of the tether, via the opening to the tank, to a member in the tank, in which said tether is of sufficient length when said cap is removed that an operator has access to the opening while said cap is tethered to said tank by said tether to said member in the tank.

16. The method according to claim 15 further comprising the step of providing an opening in said member through said tether is slidable, and said other end of the tether is larger than said opening in said member so that said member and said tether are always retained coupled to each other.

17. The method according to claim 15 wherein the member is retainable in the tank.

18. The method according to claim 15 wherein the member has a filter.
